(19) United States
(12) Patent Application Publication
(10) Pub. No.: US 2023/0411735 A1
(43) Pub. Date: Dec. 21, 2023

(54) SECONDARY BATTERY SYSTEM

(71) Applicant: TOYOTA JIDOSHA KABUSHIKI KAISHA, Toyota-shi Aichi-ken (JP)

(72) Inventor: Keiichi MINAMI, Tagata-gun Shizuoka-ken (JP)

(73) Assignee: TOYOTA JIDOSHA KABUSHIKI KAISHA, Toyota-shi Aichi-ken (JP)

(21) Appl. No.: 18/135,888

(22) Filed: Apr. 18, 2023

(30) Foreign Application Priority Data
Jun. 17, 2022 (JP) 2022-098344

(51) Int. Cl. H01M 10/6571; H01M 10/63; H01M 10/0562; H01M 10/48

(52) U.S. Cl. CPC H01M 10/6571; H01M 10/63; H01M 10/0562; H01M 10/48; H01M 2300/0071; H01M 2300/0068

(57) ABSTRACT

The secondary battery system according to the present disclosure includes a secondary battery, a heating device, and a control device, and the secondary battery includes a positive electrode and a negative electrode, and one or both of the positive electrode and the negative electrode include an active material, a solid electrolyte, and a Li containing salt, and the active material includes a material whose volume changes with charging and discharging of the secondary battery, and a target heated by the heating device includes Li containing salt, and the control device controls the heating by the heating device such that when it is determined that the performance of the secondary battery is equal to or lower than a certain level, the temperature of Li containing salt becomes equal to or higher than the melting point of Li containing salt.

### CROSS-REFERENCE TO RELATED APPLICATION

This application claims priority to Japanese Patent Application No. 2022-098344 filed on Jun. 17, 2022 incorporated herein by reference in its entirety.

### BACKGROUND

### 1. Technical Field

The present application discloses a secondary battery system.

### 2. Description of Related Art

Japanese Unexamined Patent Application Publication No. 11-007942 (JP 11-007942 A) discloses an all-solid-state lithium ion battery including a positive electrode and a negative electrode. One or both of the positive electrode and the negative electrode contain an active material and an inorganic solid electrolyte powder, and the active material is coated with a lithium ion conductive polymer. Japanese Unexamined Patent Application Publication No. 2012-138299 (JP 2012-138299 A) discloses a method of manufacturing an all-solid-state lithium secondary battery. The method of manufacturing the all-solid-state lithium secondary battery includes supplying current between a positive electrode active material layer and a negative electrode active material layer to repair a short-circuit defect occurring between the positive electrode active material layer and the negative electrode active material layer. Japanese Unexamined Patent Application Publication No. 2017-045515 (JP 2017-045515 A) discloses a negative electrode for a secondary battery having a current collector, an active material layer, and a self-healing polymer layer.

### SUMMARY

The volume of some active materials included in the positive electrode and the negative electrode changes as the battery is charged and discharged. When the volume of the active material changes as the battery is charged and discharged, cracks, gaps, and the like may occur in the positive electrode and the negative electrode, and the cycle characteristics of the battery may deteriorate. Such an issue is likely to occur particularly when a solid electrolyte is included together with the active material in the positive electrode or the negative electrode. A new technique for recovering the performance is required when the performance of the secondary battery is deteriorated.

The present application discloses the following aspects for solving the above issue.

### First Aspect

A secondary battery system includes:
a secondary battery;
a heating device; and
a control device.
The secondary battery includes a positive electrode and a negative electrode.
One or both of the positive electrode and the negative electrode contain an active material, a solid electrolyte, and a Li containing salt.
The active material contains a material of which volume changes as the secondary battery is charged and discharged.
A target to be heated by the heating device contains the Li containing salt.
When performance of the secondary battery is determined to be equal to or lower than a certain level, the control device controls heating by the heating device such that a temperature of the Li containing salt is equal to or higher than a melting point of the Li containing salt.

### Second Aspect

In the secondary battery system according to the first aspect, the Li containing salt has a melting point below 60° C.

### Third Aspect

The secondary battery system according to the first or second aspect further includes a voltage measurement device.
The voltage measurement device measures a voltage of the secondary battery.
The performance of the secondary battery is based on the voltage.

### Fourth Aspect

In the secondary battery system according to any one of the first to third aspects, when performance of the secondary battery is determined to exceed a certain level, the control device controls heating by the heating device such that a temperature of the Li containing salt is lower than the melting point.

### Fifth Aspect

In the secondary battery system according to any one of the first to fourth aspects, the active material contains S.

### Sixth Aspect

In the secondary battery system according to any one of the first to fourth aspects, the active material contains Si.

### Seventh Aspect

In the secondary battery system according to any one of the first to sixth aspects, the solid electrolyte contains a sulfide.

### Eighth Aspect

In the secondary battery system according to any one of the first to seventh aspects, the Li containing salt contains a first cation and a second cation.
The first cation is at least one selected from a group consisting of an ammonium ion, a phosphonium ion, a pyridinium ion, and a pyrrolidinium ion.
The second cation is a lithium ion.

### Ninth Aspect

In the secondary battery system according to any one of the first to eighth aspects, the Li containing salt contains a first cation and a second cation.
The first cation is a tetraalkylammonium ion.
The second cation is a lithium ion.

### Tenth Aspect

In the secondary battery system according to any one of the first to ninth aspects, the Li containing salt contains at least one anion selected from a group consisting of a halogen ion, a halide ion, a hydrogen sulfate ion, a sulfonylamide ion, and a complex ion containing H.

### Eleventh Aspect

In the secondary battery system according to any one of the first to tenth aspects, the Li containing salt contains one or both of a first anion and a second anion.
The first anion is one or both of the halogen ion and the hydrogen sulfate ion.
The second anion is a sulfonylamide anion.

The secondary battery system according to the present disclosure can recover the performance of the secondary battery when the performance of the secondary battery is deteriorated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a configuration of a secondary battery system;

FIG. 2 illustrates an example of a control flow in the secondary battery system.

### DETAILED DESCRIPTION OF EMBODIMENTS

### 1. Secondary Battery System

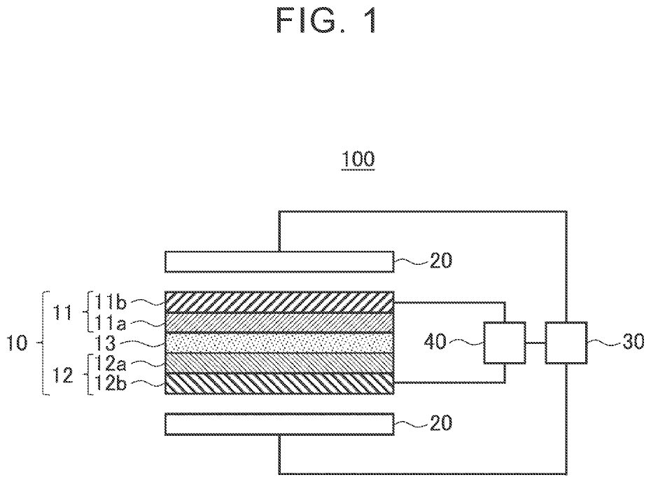

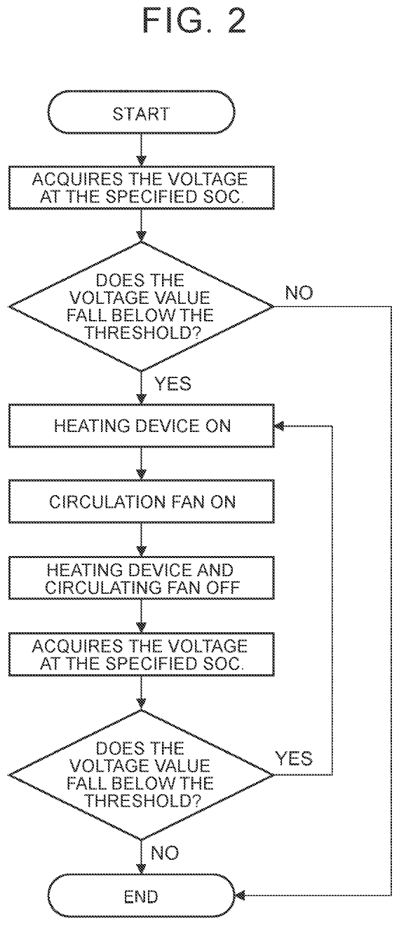

Hereinafter, an embodiment of a secondary battery system of the present disclosure will be described with reference to the drawings. As illustrated in FIGS. 1 and 2, a secondary battery system 100 according to an embodiment includes a secondary battery 10, a heating device 20, and a control device 30. The secondary battery 10 includes a positive electrode 11 and a negative electrode 12. One or both of the positive electrode 11 and the negative electrode 12 may include an active material, a solid electrolyte, and a Li containing salt. The active material includes a material whose volume changes with charging and discharging of the secondary battery 10. The target to be heated by the heating device 20 includes Li containing salt. When it is determined that the performance of the secondary battery 10 is equal to or lower than a certain level, the control device 30 controls the heating by the heating device 20 so that the temperature of Li containing salt is equal to or higher than the melting point of Li containing salt.

### 1.1 Secondary Battery

The secondary battery 10 includes a positive electrode 11 and a negative electrode 12. The secondary battery 10 may include an electrolyte layer 13 between the positive electrode 11 and the negative electrode 12. Further, the secondary battery 10 may have a configuration (not shown). One or both of the positive electrode 11 and the negative electrode 12 includes a predetermined active material, a solid electrolyte, and a predetermined Li containing salt. That is, the positive electrode 11 may include a predetermined active material, a solid electrolyte, and a predetermined Li containing salt. The negative electrode 12 may include a predetermined active material, a solid electrolyte, and a predetermined Li containing salt. Both the positive electrode 11 and the negative electrode 12 may contain a predetermined active material, a solid electrolyte, and a predetermined Li containing salt.

### 1.1.1 Positive Electrode

As shown in FIG. 1, the positive electrode 11 may have a positive electrode active material layer 11a and a positive electrode current collector 11b contacting the layer 11a. The positive electrode active material 11a may include a predetermined active material, a solid electrolyte, and a predetermined Li containing salt.

The positive electrode active material layer 11a includes at least a positive electrode active material, and may include a solid electrolyte and a predetermined Li containing salt. In addition, the positive electrode active material 11a may include a conductive auxiliary agent, a binder, and the like. Further, the positive electrode active material layers 11a may contain various additives. The content of the respective components in the positive electrode active material layer 11a may be appropriately determined in accordance with the desired battery performance. For example, the total solid content of the positive electrode active material 11a as 100 wt %, the content of the active cathode material, wt % or more, 50 wt % or more, 60 wt % or more or 70 wt % or more may be. The content of the positive electrode active material may be 100% by mass or less, 95% by mass or less, or 90% by mass or less. Alternatively, the entire positive electrode active material layer 11a may be 100% by volume, and the positive electrode active material and, optionally, the solid electrolyte, Li containing salt, the conductive auxiliary agent, and the binder may be contained in an amount of 85% by volume or more, 90% by volume or more, or 95% by volume or more. The remainder may be a void or other component. The shapes of the positive electrode active material layers 11a are not particularly limited. The positive electrode active material layer 11a may be, for example, a sheet-like positive electrode active material layer having a substantially flat surface. The thickness of the positive electrode active material layers 11a is not particularly limited. The thickness of the positive electrode active material layers 11a may be, for example, 0.1 μm or more, 1 μm or more, or 10 μm or more. The thickness of the positive electrode active material layers 11a may be 2 mm or less, 1 mm or less, or 500 μm or less.

As the positive electrode active material, one known as a positive electrode active material of a secondary battery may be used. For example, when a lithium-ion secondary battery is configured, a lithium-containing complex oxide (lithium cobaltate, lithium nickelate, LiNi_{1/3}Co_{1/3}Mn_{1/3}O₂, lithium manganate, a spinel-based lithium compound, or the like), a lithium-containing complex oxide (S alone, S compound), or the like may be employed as the positive electrode active material. Among them, the positive electrode active material containing S has a large volume change due to charging and discharging of the secondary battery 10. It is believed that the positive electrode active material containing S provides a more pronounced effect according to the system 100 of the present disclosure. Only one positive electrode active material may be used alone. In addition, two or more types of positive electrode active materials may be used in combination. The positive electrode active material may be in a particulate form, for example. The size is not particularly limited. The particles of the positive electrode active material may be solid particles. The particles of the positive electrode active material may be hollow particles. The particles of the positive electrode active material may be particles having voids (porous particles). The particles of the positive electrode active material may be primary particles. The particles of the positive electrode active material may be secondary particles in which a plurality of primary particles is aggregated. The mean particle diameter (D50) of the particles of the positive electrode active material may be, for example, 1 nm or more, 5 nm or more, or 10 nm or more. The mean particle size (D50) of the particles of the positive electrode active material may also be less than 500 μm, 100 μm or less, less than 50 μm, or less than 30 μm. The mean particle diameter (D50) is the particle diameter (median diameter) at an integrated value of 50% in the volume-based particle size distribution determined by the laser diffraction/scattering method.

The surface of the positive electrode active material may be covered with a protective layer containing an ion conductive oxide. That is, the positive electrode 11 may include a composite including a positive electrode active material and a protective layer provided on a surface thereof. As a result, a reaction or the like between the positive electrode active material and a sulfide (for example, a sulfide solid electrolyte, which will be described later) is easily suppressed. As the lithium ion conductive oxide, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄ are exemplified. The coverage (area ratio) of the protective layer may be, for example, 70% or more, 80% or more, or 90% or more. The thickness of the protective layers may be, for example, greater than or equal to 0.1 nm or greater than or equal to 1 nm. The thickness of the protective layers may be less than or equal to 100 nm or less than or equal to 20 nm.

As the solid electrolyte, one known as a solid electrolyte of a secondary battery may be used. The solid electrolyte may be an inorganic solid electrolyte or an organic polymer electrolyte. In particular, the inorganic solid electrolyte has ionic conductivity and heat resistance. Examples of the inorganic solid electrolyte include oxide solid electrolytes such as lithium lanthanum dylconate, LiPON, Li_{1+X}AlₓGe_{2-X}(PO₄)₃, Li—SiO-based glass, and Li—Al—S—O-based glass; and sulfide solid electrolytes such as Li₂S—P₂S₅, Li₂S—SiS₂, LiI—Li₂S-SiS₂, LiI—Si₂S—P₂S₅, Li₂S—P₂S₅—LiI—LiBr, LiI—Li₂S—P₂S₅, LiI—Li₂S—P₂₀₅, LiI—Li₃PO₄—P₂S₅, and Li₂S—P₂S₅—GeS₂. In particular, the solid electrolyte containing sulfide (sulfide solid electrolyte), in particular, the solid electrolyte containing at least Li, S, and P as constituent elements has a higher performance. The solid electrolyte may be amorphous. The solid electrolyte may be crystalline. The solid electrolyte may be, for example, in particulate form. Only one type of solid electrolyte may be used alone. Two or more types of solid electrolytes may be used in combination.

The melting point of Li containing salt can be appropriately selected in view of the heat resistance of the components of the secondary battery. If the melting point of Li containing salt is too high, the temperature of Li containing salt may be higher than or equal to the melting point, and if the salt is heated by the heating device 20, there is a possibility that the material constituting the battery may have an adverse effect on the material (for example, the sealing portion of the laminate film may be deteriorated). For example, Li containing salt may have a melting point of less than 60° C. The lower limit of the melting point of Li containing salt is not particularly limited. When heating by the heating device is not performed, Li containing salt may be a solid having a melting point less than the melting point. For example, the melting point of Li containing salt may be 20° C. or higher, 25° C. or higher, 30° C. or higher, 35° C. or higher, 40° C. or higher, 45° C. or higher, or 50° C. or higher. Li containing salt may be particulate prior to being heated by the heating device 20. The size is not particularly limited. The mean particle diameter (D50) of the particles of Li containing salt may be, for example, equal to or greater than 1 nm, equal to or greater than or equal to or greater than 10 nm. The mean particle size (D50) of the particles of Li containing salt may be not more than 500 μm, not more than 100 μm, not more than 50 μm, or not more than 30 μm.

Li containing salt may have a first cation and a second cation. The first cation may be at least one selected from ammonium ions, phosphonium ions, pyridinium ions, and pyrrolidinium ions. The second cation may be a lithium ion. The first cation may be a tetraalkylammonium ion. The second cation may be a lithium ion. When Li containing salt has the first cation, Li containing salt tends to have a lower melting point than when it does not have the first cation.

Specific examples of the first cation include the following.
Tetrahexylammonium ion, N(C₆H₁₃)₄⁺
Tetraoctylammonium ion, N(C₈H₁₇)₄⁺
Tetrabutylammonium ion, N(C₄H₉)₄⁺
Tetraethylammonium ion, N(C₂H₅)₄⁺
Tetraamylammonium ion, N(C₅H₁₁)₄⁺
Tetradecylammonium ion, N(C₁₀H₂₁)₄⁺
Ethyldimethylphenylethyl ion, N(CH₃)₂(C₂H₅)(C₂H₅C₆H₅)⁺
1-methyl-1-propylpiperidinium ion, (CH₃(C₃H₇)N(C₅H₁₀)⁺
Amyltriethylammonium ion, N(C₂H₅)₃(C₅H₁₁)⁺
Methyl trioctylammonium ion, N(CH₃)₃(C₄H₁₇)⁺

The molar ratio of the first cation and the second cation constituting Li containing salt is not particularly limited. When Li containing salt has both a first cation and a second cation, the melting point of Li containing salt is lowered as compared to when each has alone. The molar ratio of the second cation to the first cation (the second cation/the first cation) may be 0.05 or more and 19.0 or less from the viewpoint of greatly lowering the melting point of Li containing salt and further enhancing the lithium-ion conductivity. The molar ratio may be 0.1 or more, 0.2 or more, 0.3 or more, 0.4 or more, 0.5 or more, 0.6 or more, 0.7 or more, 0.8 or more, 0.9 or more, or 1.0 or more. The molar ratio may be 10.0 or less, 9.5 or less, 9.0 or less, 8.5 or less, 8.0 or less, 7.5 or less, 7.0 or less, 6.5 or less, 6.0 or less, 5.5 or less, or 5.0 or less. Even if the molar ratio of the second cation to the first cation constituting Li containing salt is as high as 1.0 or more (for example, the concentration of lithium ions in the total cation is 50 mol % or more), the melting point of Li containing salt is sufficiently low, and may be, for example, less than 60° C.

The cations constituting Li containing salt may be composed of only the first cations and the second cations. In addition, the cations constituting Li containing salt may contain other cations that differ from the first cations. Examples of the other cations include ions containing a poor metal element. Examples of the poor metal include Al and Ga. The ratio of the total of the above-mentioned first and second cations to the total cation comprising Li containing salt may be 50 mol %, 60 mol %, 70 mol %, 80 mol %, 90 mol %, 95 mol %, 99 mol % or mole or 100 mol %

Li containing salt can have a variety of anions. For example, Li containing salt may have at least one anion selected from a complex ion including a halogen ion, a halide ion, a hydrogen sulfate ion, a sulfonylamide ion, and H. Alternatively, Li containing salt may have one or both of the first anion and the second anion. The first anion may be one or both of a halogen ion and a hydrogen sulfate ion. The second anion may be a sulfonylamide anion. According to a new finding of the present inventors, when Li containing salt has the above-described anion, particularly when Li containing salt has one or both of the halogen ion and the hydrogen sulfate ion, and particularly when Li containing salt has the halogen ion, the melting point of Li containing salt tends to be specifically lowered. Further, according to the present inventor's new knowledge, even when Li containing salt has a sulfonylamide anion, the melting point of Li containing salt tends to decrease specifically. Further, according to the new knowledge of the present inventors, when Li containing salt has a plurality of types of anions, for example, when Li containing salt has a first anion that is one or both of a halogen ion and a hydrogen sulfate ion, and a second anion that is a sulfonylamide anion, the melting point of Li containing salt tends to decrease specifically.

The halogen ion may be, for example, one or both of a bromine ion and a chloride ion.

Examples of the sulfonylamide anion include a trifluoromethanesulfonylamide anion (TFSA anion, (CF₃SO₂)₂N⁻), a fluorosulfonylamide anion (FSA anion, (FSO₂)₂N⁻), a fluorosulfonyl (trifluoromethanesulfonyl) amide anion (FTA anion, FSO₂(CF₃SO₂)₂N⁻), and the like. Only one sulfonylamide anion may be used. Two or more kinds of sulfonylamide anions may be combined. Among the sulfonylamide anions, TFSA anions are less polar. TFSA anions are particularly less reactive with other cell components. In this regard, when Li containing salt has TFSA anions, the reactivity of Li containing salt with other cell components is more likely to be suppressed.

The complex ion containing H may have, for example, an element M containing at least one of a non-metal element and a metal element, and H bonded to the element M. In the complex ion containing H, the element M as a central element and H surrounding the element M may be bonded to each other via a covalent bond. The complex ion containing H may be represented by (MₘHₙ)^{α-}). In this case, m is any positive number. n and α may be any positive number depending on m and the equivalent number of the element M. The element M may be a non-metal element or a metal element capable of forming a complex ion. For example, the element M may include at least one of B, C, and N as a non-metallic element. The element M may contain B. Further, for example, the element M may include at least one of Al, Ni and Fe as the metallic element. In particular, when the complex ion contains B, or when the complex ion contains C and B, higher ion conductivity is easily ensured. Specific examples of complex ions containing H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. In particular, when (CB₉H₁₀)⁻, (CB₁₁H₁₂)⁻, or a combination thereof is used, higher ionic conductivity is likely to be ensured.

When Li containing salt contains the first anion and the second anion, the molar ratio of the first anion and the second anion is not particularly limited. The molar ratio of the second anion to the first anion (second anion/first anion) may be greater than 0 and less than or equal to 19.0. The molar ratio may be 0.1, 0.2, 0.3, 0.4, or 0.5 or more. The molar ratio may be 10.0 or less, 9.5 or less, 9.0 or less, 8.5 or less, 8.0 or less, 7.5 or less, 7.0 or less, 6.5 or less, 6.0 or less, 5.5 or less, or 5.0 or less.

Li containing salt may include other anions different from the above-exemplified anions (at least one anion selected from a complex ion including a halogen ion, a halide ion, a hydrogen sulfate ion, a sulfonylamide ion, and H). The total ratio of the above-exemplified anions to the total of the anions constituting Li containing salt may be 50 mol % or more, 60 mol % or more, 70 mol % or more, 80 mol % or more, 90 mol % or more, 95 mol % or more, 99 mol % or more, or 100 mol %.

The present inventors have found an exemplary composition of Li containing salt and its melting point.

AmTEA·TFSA+Li·TFSA (1)
First cation: N(C₂H₅)₃(C₅H₁₁)⁺
Second cation: Li⁺
Anions: TFSA⁻
Molar ratio of the first cation to the second cation: 1.0
Melting point: 50° C.

MTOA·TFSA+LiTFSA (2)
First cation: N(CH₃)(C₈H₁₇)₃⁺
Second cation: Li⁺
Anions: TFSA⁻
Molar ratio of the first cation to the second cation: 1.0
Melting point: 50° C.

TAmA·Br+Li·TFSA (3)
First cation: N(C₅H₁₁)₄⁺
Second cation: Li⁺
First anion: Br⁻
Second anion: TFSA⁻
Molar ratio of the first cation to the second cation: 1.0
Molar ratio of the first anion to the second anion: 1.0
Melting point: 30° C.

Examples of the conductive auxiliary agent include carbon materials such as gas phase carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, particulate or fibrous. The size is not particularly limited. Only one type of the conductive auxiliary agent may be used alone. Two or more kinds of the conductive auxiliary agents may be used in combination.

Examples of the binder include a butadiene rubber (BR)-based binder, a butylene rubber (IIR)-based binder, an acrylate-butadiene rubber (ABR)-based binder, a styrene-butadiene rubber (SBR)-based binder, a polyvinylidene fluoride (PVdF)-based binder, and a polytetrafluoroethylene (PTFE)-based binder and a polyimide (PI)-based binder. Only one binder may be used alone. Two or more kinds of binders may be used in combination.

As the positive electrode current collector 11b, any of the common positive electrode current collectors can be employed as the positive electrode current collector of the secondary pond. The positive electrode current collector 11b may be a foil, a plate, a mesh, a punching metal, a foam, or the like. The positive electrode current collector 11b may be formed of a metal foil or a metal mesh. In particular, the metal foil has handling properties and the like. The positive electrode current collector 11b may be formed of a plurality of foils. The positive electrode current collector 11b may be made of Cu, Ni, Cr, Au, Pt, Ag, Al, Fe, Ti, Zn, Co, stainless-steel, or the like. In particular, from the viewpoint of ensuring oxidation resistance or the like, the positive electrode current collector 11b may include Al. The positive electrode current collector 11b may have a plurality of coating layers for adjusting the resistivity thereof. The positive electrode current collector 11b may be formed by plating or depositing the metal on a metal foil or a base material. When the positive electrode current collector 11b is formed of a plurality of metal foils, the positive electrode current collector 11b may have some layers between the plurality of metal foils. The thickness of the positive electrode current collector is not particularly limited. The thickness of the positive electrode current collector may be, for example, 0.1 μm or more or 11 μm or more. The thickness of the positive electrode current collector may be 1 mm or less, or 100 μm or less.

### 1.1.2 Negative Electrode

As shown in FIG. 1, the negative electrode 12 may have a negative electrode active material layer 12a and a negative electrode current collector 12b contacting the layer 12a. The negative electrode active material layer 12a may include a predetermined active material, a solid electrolyte, and a predetermined Li containing salt.

The negative electrode active material layer 12a includes at least a negative electrode active material. The negative electrode active material layer 12a may include a solid electrolyte and a predetermined Li containing salt. In addition, the negative electrode active material layer 12a may include a conductive auxiliary agent, a binder, and the like. Further, the negative electrode active material layer 12a may contain various additives. The content of the respective components in the negative electrode active material layer 12a may be appropriately determined in accordance with the desired battery performance. For example, the entire solids of the negative electrode active material layer 12a as 100% by mass, the content of the negative active material may be 40% by mass or more, 50% by mass or more, 60% by mass or more or 70% by mass or more. The content of the negative electrode active material may be 100% by mass or less, 95% by mass or less, or 90% by mass or less. Alternatively, the negative electrode active material layer 12a may be 100% by volume, and the negative electrode active material and, optionally, the solid electrolyte, Li containing salt, the conductive auxiliary agent, and the binder may be contained in a total amount of 85% by volume or more, 90% by volume or more, or 95% by volume or more. The remainder may be a void or other component. The shapes of the negative electrode active material layer 12a are not particularly limited. The negative electrode active material layer 12a may be, for example, a sheet-like negative electrode active material layer having a substantially flat surface. The thickness of the negative electrode active material layer 12a is not particularly limited. The thickness of the negative electrode active material layer 12a may be, for example, 0.1 μm or more, 1 μm or more, or 10 μm or more. The thickness of the negative electrode active material layer 12a may be 2 mm or less, 1 mm or less, or 500 μm or less.

As the negative electrode active material, a material known as a negative electrode active material of a secondary battery may be used. For example, when a lithium-ion secondary battery is configured, as the negative electrode active material, a material containing Si (a single Si, a Si alloy, a Si compound), a material containing carbon (graphite, hard carbon, etc.), a material containing an oxide (lithium titanate, etc.), and a material containing Li (metallic lithium, lithium alloy, etc.) can be employed. Among them, the negative electrode active material containing Si has a large volume change due to charging and discharging of the secondary battery 10. Therefore, it is believed that a more pronounced effect of the system 100 of the present disclosure is obtained. Only one type of the negative electrode active material may be used alone. Two or more kinds of the negative electrode active material may be used in combination. The negative electrode active material may be in a particulate form, for example. The size is not particularly limited. The particles of the negative electrode active material may be solid particles. The particles of the negative electrode active material may be hollow particles. The particles of the negative electrode active material may be particles having voids (porous particles). The particles of the negative electrode active material may be primary particles. The particles of the negative electrode active material may be secondary particles in which a plurality of primary particles is aggregated. The mean particle diameter (D50) of the particles of the negative electrode active material may be, for example, 1 nm or more, 5 nm or more, or 10 nm or more. The mean particle size (D50) of the particles of the negative electrode active material may also be 500 μm or less, 100 μm or less, 50 μm or less, or 30 μm or less.

The solid electrolyte, Li containing salt, the conductive auxiliary agent, the binder, and the like that can be included in the negative electrode active material layer 12a may be appropriately selected from those exemplified as those that can be included in the positive electrode active material layer described above, for example.

Any of the negative electrode current collector 12b generally used as a negative electrode current collector of batteries can be adopted. The negative electrode current collector 12b may be a foil, a plate, a mesh, a punching metal, a foam, or the like. The negative electrode current collector 12b may be a metal foil or a metal mesh. The negative electrode current collector 12b may alternatively be a carbon sheet. In particular, the metal foil has handling properties and the like. The negative electrode current collector 12b may be formed of a plurality of foils or sheets. The negative electrode current collector 12b may be made of Cu, Ni, Cr, Au, Pt, Ag, Al, Fe, Ti, Zn, Co, stainless-steel, or the like. In particular, from the viewpoint of ensuring reduction resistance and from the viewpoint of difficulty in alloying with lithium, the negative electrode current collector 12b may include at least one metal selected from Cu, Ni and stainless steel. The negative electrode current collector 12b may include a plurality of coating layers for adjusting the resistivity thereof. The negative electrode current collector 12b may be formed by plating or depositing the metal on a metal foil or a base material. When the negative electrode current collector 12b is formed of a plurality of metal foils, the negative electrode current collector 12b may have some layers between the plurality of metal foils. The thickness of the negative electrode current collector 12b is not particularly limited. The thickness of the negative electrode current collector 12b may be, for example, 0.1 μm or more or 1 μm or more. The thickness of the negative electrode current collector 12b may be 1 mm or less, or 100 μm or less.

### 1.1.3 Electrolyte Layer

The electrolyte layer 13 is disposed between the positive electrode 11 and the negative electrode 12. The electrolyte layer 13 may function as a separator. The electrolyte layer 13 includes at least a solid electrolyte. The electrolyte layer 13 may further optionally include a binder or the like. The electrolyte layer 13 may further contain various additives. The content of each component in the electrolyte layer 13 is not particularly limited. The content of each component in the electrolyte layer 13 may be appropriately determined according to the desired battery performance. The shape of the electrolyte layer 13 is not particularly limited. The shape of the electrolyte layer 13 may be, for example, a sheet shape having a substantially flat surface. The thickness of the electrolyte layer 13 is not particularly limited. The thickness of the electrolyte layer 13 may be, for example, 0.1 μm or more or 1 μm or more. The thickness of the electrolyte layer 13 may be less than or equal to 2 mm or less than or equal to 1 mm.

The solid electrolyte, the binder, and the like included in the electrolyte layer 13 may be appropriately selected from those exemplified as the electrolytes that can be included in the positive electrode active material layer 11a and the negative electrode active material layer 12a described above.

### 1.1.4 Other Configurations

In the secondary battery 10, each of the above-described configurations may be accommodated in an exterior body. As the exterior body, any known exterior body of the battery can be adopted. For example, an exterior body made of a laminate film may be employed. The secondary battery 10 may include a plurality of positive electrodes 11. The secondary battery 10 may include a plurality of negative electrodes 12. The secondary battery may include a plurality of electrolyte layers 13. Further, the plurality of secondary batteries 10 may be arbitrarily electrically connected to each other, and may be arbitrarily superposed to form the plurality of secondary batteries 10 as a battery pack. In this case, the assembled battery may be accommodated in a known battery case. The secondary battery 10 may have an obvious configuration such as a necessary terminal. As the shape of the secondary battery 10, for example, coin-type, laminate-type, cylindrical, and square-type, and the like.

### 1.2 Heating Device

As shown in FIG. 1, the secondary battery system 100 includes a heating device 20. The target to be heated by the heating device 20 includes Li containing salt described above. In other words, the heating device 20 may be configured to be capable of heating at least Li containing salt. The heating device 20 may be configured to heat at least the positive electrode 11 of the secondary battery 10, for example. The heating device 20 may be configured to heat at least the negative electrode 12. The heating device 20 may be configured to heat the whole of the positive electrode 11, the negative electrode 12, and the electrolyte layer 13 of the secondary battery 10.

The heating method of the heating device 20 is not particularly limited. The heating system of the heating device 20 may be any system capable of heating Li containing salt to a temperature equal to or higher than the melting point. For example, various methods such as resistance heating, induction heating, dielectric heating, microwave heating, hot air heating, and the like may be employed. The heating device 20 may be configured to be capable of switching between a heating mode in which the temperature of Li containing salt is equal to or higher than the melting point and a heating or non-heating mode in which the temperature of Li containing salt is lower than the melting point.

The position at which the heating device 20 is installed and the number of the heating devices 20 are not particularly limited. FIG. 1 shows a configuration in which the heating device 20 is disposed on each of the positive electrode 11 side and the negative electrode 12 side. However, the position and number of the heating devices 20 are not limited thereto. The heating device 20 may be disposed inside the exterior body of the secondary battery 10, for example. The heating device 20 may be disposed outside the exterior body of the secondary battery 10. The heating device 20 may be configured to heat one secondary battery 10. The heating device 20 may be configured to heat the plurality of secondary batteries 10.

The maximum value of the heating temperature by the heating device 20 may be equal to or higher than the melting point of Li containing salt. On the other hand, from the viewpoint of suppressing material deterioration of the secondary battery 10 and the like, the heating temperature by the heating device 20 may be 80° C. or less, 70° C. or less, or 60° C. or less.

### 1.3 Control Device

As illustrated in FIG. 1, the secondary battery system 100 includes a control device 30. The control device 30 controls heating by the heating device 20. The control device 30 may include a CPU, RAM, ROM or the like.

As described above, one or both of the positive electrode 11 and the negative electrode 12 of the secondary battery 10 includes the solid electrolyte and an active material whose volume changes with charge and discharge. Therefore, when charging and discharging of the secondary battery 10 are repeated, cracks tend to occur in the active material or the solid electrolyte due to volume change of the active material. Further, due to the volume change of the active material, a gap is likely to occur between the active material and the active material, between the active material and the solid electrolyte, or between the solid electrolyte and the solid electrolyte. Such cracks and gaps may cause interruptions in the ion conduction path and the conduction path in the electrode. Then, the performance of the secondary battery 10 may be reduced to a certain level or less.

On the other hand, when it is determined that the performance of the secondary battery 10 is equal to or lower than a certain level, the control device 30 controls the heating by the heating device 20 so that the temperature of Li containing salt is equal to or higher than the melting point thereof. The heating time by the heating device 20 is not particularly limited. The heating time by the heating device 20 may be, for example, a time until Li containing salt is sufficiently liquefied. For example, when it is determined that the performance of the secondary battery 10 is equal to or less than a certain level, the control device 30 may control the switching of ON and OFF of the heating device 20 so that the heating by the heating device 20 is started. Alternatively, when it is determined that the performance of the secondary battery 10 is equal to or less than a certain level, the control device 30 may control the heating of the heating device 20 so as to increase the amount of heating by the heating device 20. As described above, by controlling the heating by the heating device 20 and heating Li containing salt to a temperature equal to or higher than the melting point by the control device 30, it is possible to fill the cracks and gaps generated in the positive electrode 11 and the negative electrode 12 with the Li containing salt. That is, cracks and gaps in the positive electrode 11 and the negative electrode 12 are eliminated by Li containing salt. Since Li containing salt contains lithium ions, it has a certain lithium ion conductivity or conductivity. Therefore, the ion-conducting path or the conductive path interrupted by the crack or the gap is reconnected via Li containing salt. As a result, the performance of the secondary battery 10 is restored.

Whether or not the performance of the secondary battery 10 is equal to or less than a certain level can be determined based on various criteria. For example, when the ion conduction path or the conductive path in the electrode is interrupted, (1) the voltage of the secondary battery at a predetermined SOC is decreased, (2) the resistance of the secondary battery is increased, and (3) the power of the secondary battery is decreased, as compared with a case where the ion conduction path or the conductive path in the electrode is not interrupted. That is, it can be determined whether or not the performance of the secondary battery is equal to or less than a certain level with reference to the voltage, resistance, output, and the like of the secondary battery. For example, as shown in FIG. 1, the secondary battery system 100 may include a voltage measurement device 40. The voltage measurement device 40 may measure a voltage of the secondary battery 10. The performance of the secondary battery 10 may be based on the voltage. Specifically, the voltage of the secondary battery 10 at a predetermined SOC is measured by the voltage measurement device 40. When the voltage value measured by the voltage measurement device 40 is equal to or less than a certain value, it may be determined that the performance of the secondary battery 10 is equal to or less than a certain value, and the above-described control by the control device 30 may be performed.

For example, the control device 30 may determine whether or not the performance of the secondary battery is equal to or less than a certain level. Whether or not the performance of the secondary battery is equal to or less than a certain level may be determined by a device other than the control device 30. The threshold value of whether or not the performance of the secondary battery 10 is equal to or less than a certain value is not particularly limited. An appropriate threshold value may be set according to the performance required for the secondary battery 10.

When it is determined that the performance of the secondary battery 10 exceeds a certain level, the control device 30 may control the heating by the heating device 20 so that the temperature of Li containing salt is lower than the melting point thereof. For example, when it is determined that the performance of the secondary battery 10 exceeds a certain level, the control device 30 may control the switching of ON and OFF of the heating device 20 so that the heating by the heating device 20 is stopped. Alternatively, when it is determined that the performance of the secondary battery 10 exceeds a certain level, the control device 30 may control the heating of the heating device 20 so as to reduce the amount of heating by the heating device 20.

### 1.4 Voltage Measurement Device

When the secondary battery system 100 includes the voltage measurement device 40, the voltage measurement device 40 may be any device capable of measuring the voltage of the secondary battery 10. The voltage measurement device 40 may monitor voltages of the plurality of secondary batteries 10. The specific configuration of the voltage measurement device 40 is known.

### 1.5 Concrete Example of Control Flow

FIG. 2 illustrates a specific example of a control flow in the secondary battery system 100. FIG. 2 is a control flow for determining whether or not the performance of the secondary battery 10 is equal to or less than a certain level with reference to the voltage of the secondary battery 10. As described above, due to the interruption of the ion conduction path or the conduction path in the electrode, the voltage of the secondary battery 10 at a predetermined SOC gradually decreases. In the control flow illustrated in FIG. 2, when the voltage value of the secondary battery 10 is set to a threshold value and the voltage value is lower than the threshold value, the secondary battery 10 is heated using the heating device 20, the circulation fan, or the like as a ON, and Li containing salt contained in the electrode of the secondary battery 10 is heated to a melting point or higher and melted, thereby repairing the solid-solid interface in the electrode.

As shown in FIG. 2, first, the voltage-value of the secondary battery 10 at a predetermined SOC is acquired. The voltage value of the secondary battery 10 can be obtained by the voltage measurement device 40, for example.

When the voltage value of the secondary battery 10 exceeds the threshold value, it is determined that the performance of the secondary battery 10 exceeds a certain value. In this case, the heating control by the heating device 20 is not performed, and for example, the control flow is terminated while the heating device 20 remains OFF. On the other hand, when the voltage value is less than the threshold value, it is determined that the performance of the secondary battery 10 is equal to or less than a certain value. Then, the heating device 20 is turned ON, the circulation fan is turned ON, the heating of Li containing salt by the heating device 20 is started, and Li containing salt is liquefied.

After a predetermined period of time, the heating device 20 and the circulation fan are turned OFF, and the voltage of the secondary battery 10 at a predetermined SOC is acquired again. If the voltage is still below the threshold, the heating device 20 and the circulating fans are turned ON again, and Li containing salt is heated and liquefied. On the other hand, when the voltage value exceeds the threshold value, it is determined that the performance of the secondary battery 10 exceeds a certain value, and the control flow is terminated without being heated again by the heating device 20, for example, while the heating device 20 remains OFF.

### 2. Method for Recovering Performance of Secondary Battery

As described above, according to the secondary battery system 100, the interruption of the ion conduction path and the conduction path in the positive electrode 11 and the negative electrode 12 of the secondary battery 10 is eliminated, and the performance of the secondary battery 10 can be recovered. In this regard, the technology of the present disclosure also has an aspect as a method for recovering performance of a secondary battery. That is, the performance recovery method of the secondary battery of the present disclosure includes:
Determining whether the performance of the secondary battery is less than or equal to a certain level; and
When it is determined that the performance of the secondary battery is equal to or less than a certain level, the method includes performing a process of recovering the performance of the secondary battery.
The secondary battery includes a positive electrode and a negative electrode.
One or both of the positive electrode and the negative electrode include an active material, a solid electrolyte, and a Li containing salt.
The active material includes a material whose volume changes with charging and discharging of the secondary battery.
The process of recovering the performance of the secondary battery includes heating Li containing salt contained in one or both of the positive electrode and the negative electrode of the secondary battery to a temperature equal to or higher than a melting point of Li containing salt.

Details of the criterion for determining whether or not the performance of the secondary battery is equal to or less than a certain level, and details of the heating control for recovering the performance of the secondary battery are as described in the secondary battery system.

As described above, according to the technology of the present disclosure, the interruption of the ion conduction path and the conduction path in the positive electrode and the negative electrode is eliminated, and the performance of the secondary battery can be recovered. In addition, the technology of the present disclosure can also be expected to have an effect of suppressing or repairing cracking of the electrolyte layer and dendrite short-circuiting of the negative electrode.

What is claimed is:

1. A secondary battery system comprising:
a secondary battery;
a heating device; and
a control device, wherein:
the secondary battery includes a positive electrode and a negative electrode;
one or both of the positive electrode and the negative electrode contain an active material, a solid electrolyte, and a Li containing salt;
the active material contains a material of which volume changes as the secondary battery is charged and discharged;
a target to be heated by the heating device contains the Li containing salt; and
when performance of the secondary battery is determined to be equal to or lower than a certain level, the control device controls heating by the heating device such that a temperature of the Li containing salt is equal to or higher than a melting point of the Li containing salt.

2. The secondary battery system according to claim 1, wherein the Li containing salt has a melting point below 60° C.

3. The secondary battery system according to claim 1, further comprising a voltage measurement device, wherein:
the voltage measurement device measures a voltage of the secondary battery; and
the performance of the secondary battery is based on the voltage.

4. The secondary battery system according to claim 1, wherein when performance of the secondary battery is determined to exceed a certain level, the control device controls heating by the heating device such that a temperature of the Li containing salt is lower than the melting point.

5. The secondary battery system according to claim 1, wherein the active material contains S.

6. The secondary battery system according to claim 1, wherein the active material contains Si.

7. The secondary battery system according to claim 1, wherein the solid electrolyte contains a sulfide.

8. The secondary battery system according to claim 1, wherein:
the Li containing salt contains a first cation and a second cation;
the first cation is at least one selected from a group consisting of an ammonium ion, a phosphonium ion, a pyridinium ion, and a pyrrolidinium ion; and
the second cation is a lithium ion.

9. The secondary battery system according to claim 1, wherein:
the Li containing salt contains a first cation and a second cation;
the first cation is a tetraalkylammonium ion; and
the second cation is a lithium ion.

10. The secondary battery system according to claim 8, wherein the Li containing salt contains at least one anion selected from a group consisting of a halogen ion, a halide ion, a hydrogen sulfate ion, a sulfonylamide ion, and a complex ion containing H.

11. The secondary battery system according to claim 10, wherein:
the Li containing salt contains one or both of a first anion and a second anion;
the first anion is one or both of the halogen ion and the hydrogen sulfate ion; and
the second anion is a sulfonylamide anion.
